(19) United States
(12) Patent Application Publication
(10) Pub. No.: US 2025/0263967 A1
(43) Pub. Date: Aug. 21, 2025

(54) CONTROL DEVICE FOR VEHICLE

(71) Applicant: TOYOTA JIDOSHA KABUSHIKI KAISHA, Toyota-shi (JP)

(72) Inventor: Junichiro TAMAO, Tokyo (JP)

(73) Assignee: TOYOTA JIDOSHA KABUSHIKI KAISHA, Toyota-shi (JP)

(21) Appl. No.: 18/968,126

(22) Filed: Dec. 4, 2024

(30) Foreign Application Priority Data
Feb. 15, 2024 (JP) 2024-021338

(51) Int. Cl. E05F 15/71

(52) U.S. Cl. CPC E05F 15/71; E05Y 2900/531; E05Y 2900/55

(57) ABSTRACT

The cockpit is capable of executing a light show by outputting music from a speaker and operating a movable part. In addition, the cockpit can perform rainfall determination processing for determining whether rain is occurring. When the cockpit determines that it is raining, the cockpit causes music to be output from the speaker without operating an opening/closing component that can be in a second state in which the vehicle interior space and the vehicle exterior space are connected among the movable parts when the light show is executed.

### CROSS-REFERENCE TO RELATED APPLICATION

This application claims priority to Japanese Patent Application No. 2024-021338 filed on Feb. 15, 2024, incorporated herein by reference in its entirety.

### BACKGROUND

### 1. Technical Field

The disclosure relates to a control device for a vehicle.

### 2. Description of Related Art

Japanese Unexamined Patent Application Publication No. 2004-351949 (JP 2004-351949 A) describes a disclosure of an in-cabin lighting device of an automobile, which is started when an occupant enters or exits the automobile, and in which a plurality of light fixtures is sequentially turned on or off in a form that is set in advance. Also, some control devices of vehicles have a light show function of outputting music from a speaker in a form that is set in advance and also operating movable parts, such as doors, to entertain a user or a viewer.

### SUMMARY

However, depending on the situation around the vehicle, controlling the vehicle in a form that is set in advance as described above may be inconvenient.

According to an aspect of the disclosure, a control device for a vehicle for solving the above problem is a control device for controlling a movable part applied to a vehicle equipped with the movable part that is able to switch between a first state in which space inside of a vehicle cabin and space outside of the vehicle are disconnected and a second state in which the space inside of the vehicle cabin and the space outside of the vehicle are connected, and that is configured to execute rainfall determination processing for determining whether rainfall is occurring, in which when determination is made that rainfall is occurring in the rainfall determination processing, the movable part is not controlled to the second state.

According to the above configuration, the inside of the vehicle cabin can be suppressed from becoming wet when the movable part is operated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a control device of a vehicle;

FIG. 2 is a schematic diagram of a vehicle;

FIG. 3 is a flow chart illustrating a write show execution-time operation stopping process according to the first embodiment; and

FIG. 4 is a flowchart illustrating a write show execution-time operation stop process according to the second embodiment.

### DETAILED DESCRIPTION OF EMBODIMENTS

### First Embodiment

### Configuration of The Control Device

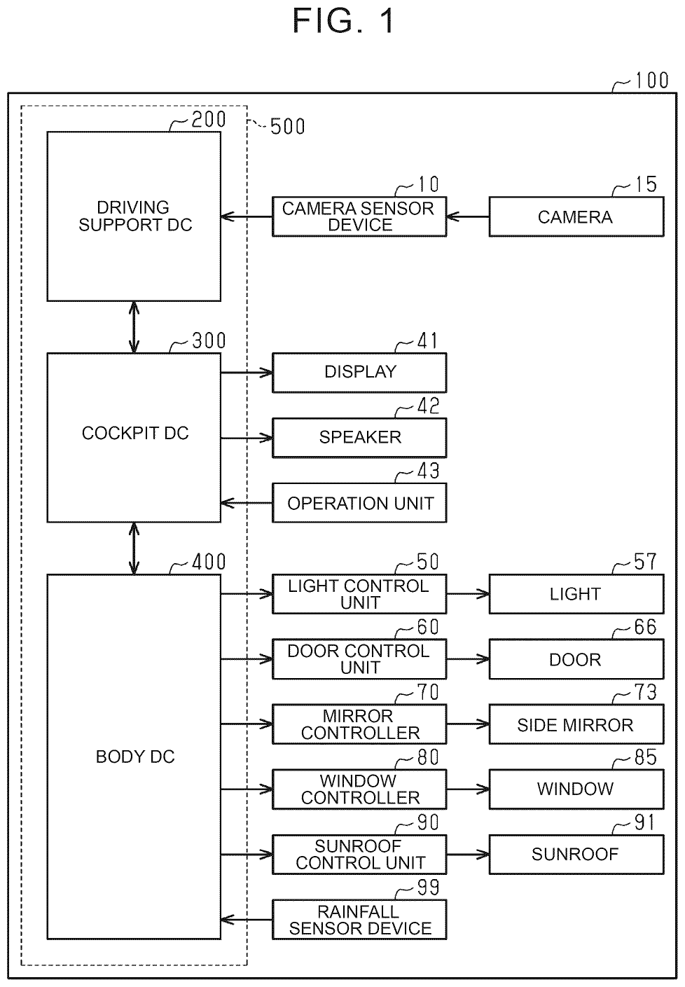

Hereinafter, a first embodiment of the present disclosure will be described with reference to FIGS. 1 to 3. First, a configuration of a control device according to the present embodiment will be described with reference to FIG. 1. As illustrated in FIG. 1, the vehicles 100 are equipped with in-vehicle devices such as a driving support DC 200, a cockpit DC 300, and a body DC 400. Note that “DC” is an abbreviation for Domain Controller. These in-vehicle devices are communicably connected to each other. The driving support DC 200, the cockpit DC 300, and the body DC 400 constitute the control device 500 of the vehicle.

The driving support DC 200 is an electronic control unit that provides a driving support function such as an automated braking device or a sudden start preventing device. A cockpit DC 300 is an electronic control unit that provides multimedia-related functions such as navigational and audio. The body DC 400 is an electronic control unit that controls various electrical components such as lights, doors, and mirrors.

### Configuration of the Driving Support DC

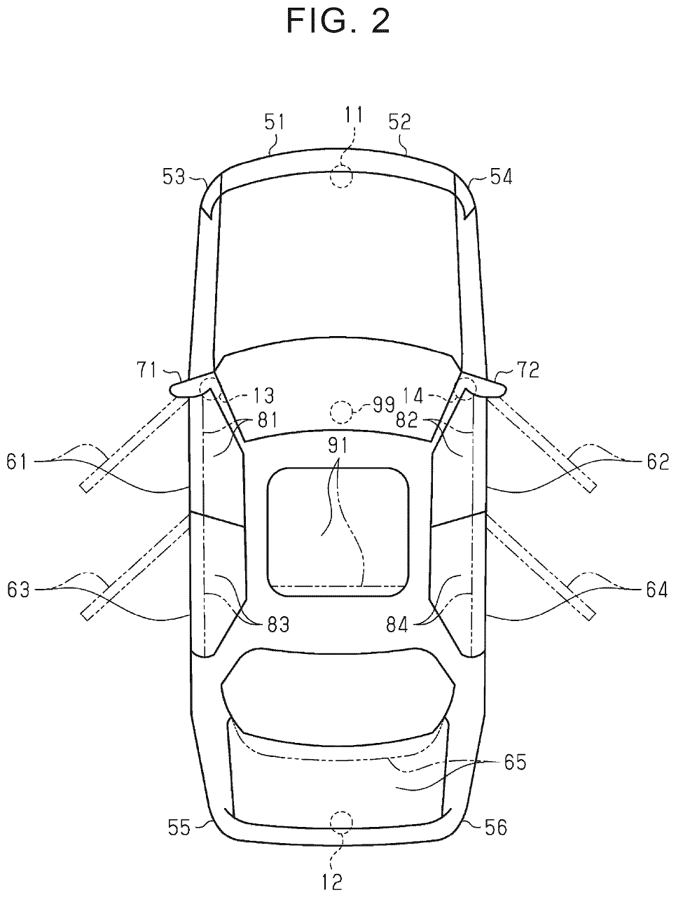

The driving support DC 200 is electrically connected to the camera sensor device 10. As illustrated in FIG. 2, the camera sensor device 10 includes cameras including a front camera 11, a rear camera 12, a left camera 13, and a right camera 14. In the following description, the front camera 11, the rear camera 12, the left camera 13, and the right camera 14 may be collectively referred to as a “camera 15”.

The front camera 11 is attached to the center of the front end portion of the vehicle 100 so as to capture an image of a scene in front of the vehicle 100. The rear camera 12 is attached to the center of the rear end portion of the vehicle 100 so as to capture an image of a landscape behind the vehicle 100. The left camera 13 is attached to a left end portion of the vehicle 100 so as to capture an image of a landscape on the left side of the vehicle 100. The right camera 14 is attached to the right end portion of the vehicle 100 so as to capture an image of the scenery on the right side of the vehicle 100.

### Configuration of Cockpit DC

The driving support DC 200 can acquire information about images of the surroundings of the vehicles 100 captured by the camera 15 via the camera sensor device 10. The cockpit DC 300 is electrically connected to the display 41, the speaker 42, and the operation unit 43 of the vehicle 100.

The display 41 includes a display unit (not shown) capable of displaying various types of information. The display 41 displays various types of information on the display unit based on an instruction from the cockpit DC 300.

The speaker 42 is configured to output sound. In the present specification, the term “sound” is intended to include any sound or music in addition to a single sound. The speaker 42 outputs a sound based on an instruction from the cockpit DC 300.

The operation unit 43 is configured to be capable of various operations. The operation unit 43 may be a touch panel type operation unit integrated with the display 41 or an operation unit independent of the display 41. The cockpit DC 300 is configured to be capable of inputting an operation signal indicating that the operation unit 43 is operated. The cockpit DC 300 can perform various types of control based on an operation signal inputted from the operation unit 43.

### Configuration of the Body DC

The body DC 400 includes a light control unit 50, a door control unit 60, a mirror control unit 70, a window control unit 80, a sunroof control unit 90, and a rainfall sensor device 99.

As illustrated in FIG. 2, the light control unit 50 is electrically connected to various lights including a left headlight 51, a right headlight 52, a left winker 53, a right winker 54, a left tail light 55, and a right tail light 56 of the vehicle 100. In the following description, various lights including the respective lights 51 to 56 are collectively referred to as “lights 57”. The light 57 is configured to be blinkable. The light control unit 50 blinks the light 57 based on an instruction from the body DC 400.

The door control unit 60 is electrically connected to various types of doors including the first door 61 to the fifth door 65 of the vehicle 100. In the following description, various doors including the first door 61 to the fifth door 65 are collectively referred to as “doors 66”. The door 66 is configured to be openable and closable by manual operation, and is configured to be openable and closable by control of the door control unit 60. The door control unit 60 opens and closes the door 66 based on an instruction from the body DC 400.

The first door 61 is rotatably supported on the left front side of the vehicle 100 so as to be openable and closable with respect to the vehicle 100. Further, the second door 62 is pivotally supported on the right front side of the vehicle 100, the third door 63 is pivotally supported on the left rear side of the vehicle 100, the fourth door 64 is pivotally supported on the right rear side of the vehicle 100, and the fifth door 65 is pivotally supported on the rear side of the vehicle 100 so as to be openable and closable with respect to the vehicle 100.

The mirror control unit 70 is electrically connected to the left side mirror 71 and the right side mirror 72 of the vehicle 100. In the following description, the left side mirror 71 and the right side mirror 72 are collectively referred to as a “side mirror 73”. The side mirror 73 is configured to be rotatable under the control of the mirror control unit 70. The mirror control unit 70 rotates the side mirror 73 based on an instruction from the body DC 400. The side mirror 73 is an example of a movable part of the vehicle 100.

The left side mirror 71 is pivotally supported on the left front side of the vehicle 100 so as to be rotatable relative to the first door 61. The right side mirror 72 is pivotally supported on the right front side of the vehicle 100 so as to be rotatable with respect to the second door 62.

The window control unit 80 is electrically connected to the fourth window 84 from the first window 81. In the following description, the first window 81 to the fourth window 84 are collectively referred to as a “window 85”. The window 85 is configured to be openable and closable under the control of the window control unit 80. The window control unit 80 opens and closes the window 85 based on an instruction from the body DC 400. That is, the window 85 of the present embodiment is a power window electrically controlled by the window control unit 80.

The first window 81 is configured to be openable and closable on the left front side of the vehicle 100. Further, the second window 82 is configured to be openable and closable in a right front side of the vehicle 100, the third window 83 is configured to be openable and closable in a left rear side of the vehicle 100, and the fourth window 84 is configured to be openable and closable in a right rear side of the vehicle 100.

The sunroof control unit 90 is electrically connected to the sunroof 91. The sunroof 91 is configured to be openable and closable under the control of the sunroof control unit 90. The sunroof control unit 90 opens and closes the sunroof 91 based on an instruction from the body DC 400. The sunroof 91 is configured to be openable and closable in a ceiling portion of the vehicle 100.

The door 66, the window 85, and the sunroof 91 can take a first state in which the vehicle interior space and the vehicle exterior space are shut off, and a second state in which the vehicle interior space and the vehicle exterior space are connected. That is, the door 66, the window 85, and the sunroof 91 are examples of movable parts of the vehicle 100, and in particular, correspond to a first movable part that can take a first state in which the vehicle interior space and the vehicle exterior space are shut off, and a second state in which the vehicle interior space and the vehicle exterior space are connected. In the following description, the door 66, the window 85, and the sunroof 91 may be collectively referred to as an “opening/closing component”. Further, in the following description, the control of the opening and closing parts of the door 66, the window 85, and the sunroof 91 to the second state may be referred to as “opening”, and the control of the opening and closing parts to the first state may be referred to as “closing”.

On the other hand, the side mirror 73 is not in the second state of connecting the vehicle interior space and the vehicle exterior space. That is, the side mirror 73 is an example of a movable part of the vehicle 100, and in particular, corresponds to a second movable part that is not a second state that connects the vehicle interior space and the vehicle exterior space.

The rainfall sensor device 99 is attached to the windshield of the vehicle 100. The rainfall sensor device 99 irradiates the windshield with infrared light. Further, the rainfall sensor device 99 receives the reflected infrared light. Then, the rainfall sensor device 99 detects raindrops on the windshield based on the amount of the received infrared light. Processing When Running Light Show

The body DC 400 can acquire information about the detection result of raindrops by the rainfall sensor device 99. The cockpit DC 300 can execute a light show process for causing the vehicles 100 to execute the light show. The light show is performed in such a manner that music is output from the speaker 42 in accordance with a predetermined program pattern and various electric components of the vehicle 100 operate.

The write show execution process can be executed triggered by an operation of the operation unit 43. The cockpit DC 300 performs a write show execution process on the basis of an operation signal inputted from the operation unit 43, and performs control so as to execute the write show. In the present embodiment, the write show execution process corresponds to a specific process.

In the light show executing process, the cockpit DC 300 controls the speaker 42 so that a predetermined musical tone is outputted. Further, in the light show execution process, the cockpit DC 300 outputs, to the body DC 400, information instructing the operation of various electrical components of the vehicle 100 at predetermined timings during the light show execution. The information instructing the operation of various electrical components of the vehicle 100 includes, for example, information instructing the blinking of the light 57, information instructing the operation of the door 66, the side mirror 73, the window 85, and the sunroof 91, and the like. The body DC 400 operates various electrical components of the vehicles 100 based on data inputted from the cockpit DC 300. That is, in the light show execution process, the control device 500 operates various movable parts including the door 66, the side mirror 73, the window 85, and the sunroof 91, and controls blinking of the light 57 of the vehicle 100. Further, the cockpit DC 300 controls the display 41 to execute an execution notification notifying that the light show is being executed as the light show starts.

After that, the cockpit DC 300 terminates the write show by terminating the write show executing process in response to the completion of the predetermined program pattern. At this time, the cockpit DC 300 controls the speaker 42 to stop outputting a predetermined musical tone. The cockpit DC 300 also controls the display 41 to terminate the running notification.

### Processing of Stopping the Operation of Movable Parts When Executing a Light Show

When executing the light show, the cockpit DC 300 performs a light show execution operation stop process for stopping the operation of the movable parts included in the various electrical components of the vehicle 100. The write show execution-time operation stop process is executed over a period during which the write show is being executed.

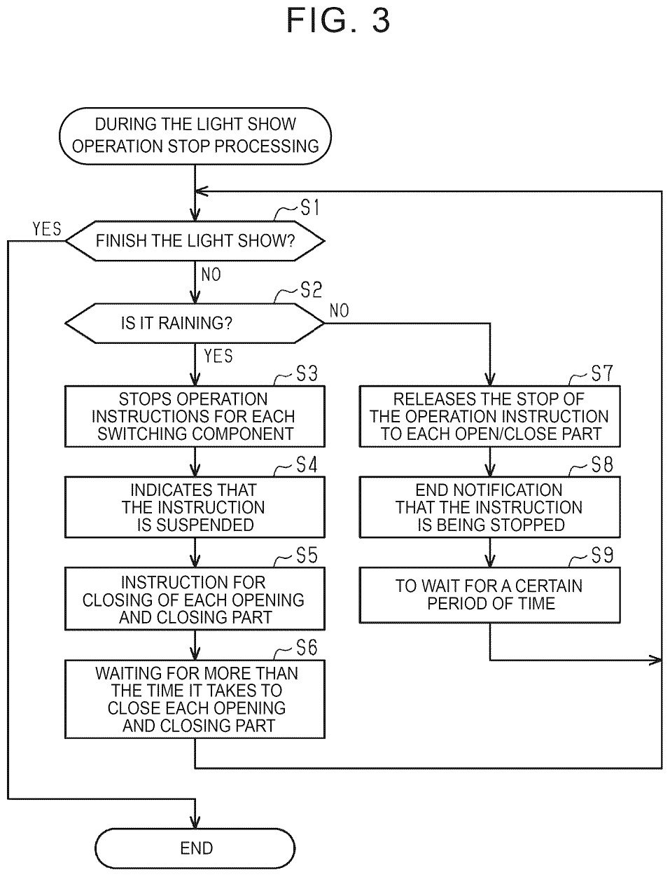

As illustrated in FIG. 3, in the write show execution-time operation stopping process, the cockpit DC 300 determines whether the write show has ended (S1). If the light show has not ended (S1: NO), the cockpit DC 300 determines if it is raining (S2). The process of S2 in the operation stopping process at the time of executing the light show corresponds to the rainfall determination process. Specifically, the cockpit DC 300 receives, from the driving support DC 200, information on images of the surroundings of the vehicles 100 captured by the camera 15 acquired via the camera sensor device 10. In addition, the cockpit DC 300 receives, from the body DC 400, the raindrop detected by the rainfall sensor device 99. Then, the cockpit DC 300 determines whether rain is occurring based on the driving support DC 200 and the data inputted from the body DC 400.

When it is determined that it is raining (S2: YES), the cockpit DC 300 performs control so as to stop the operation instruction to the respective opening/closing components (S3). Specifically, when it is determined that it is raining, the cockpit DC 300 does not cause the body DC 400 to transmit information instructing the operation of the door 66, the window 85, and the sunroof 91 in the light show executing process. That is, the cockpit DC 300 does not control the opening/closing components to be in the second condition that connects the vehicle interior space and the vehicle exterior space in the light show executing process when it is determined that the vehicle is raining.

Then, the cockpit DC 300 causes the display 41 to execute an operation stop notification, which is a notification indicating that the operation instruction to the respective opening/closing components is stopped (S4). Specifically, the cockpit DC 300 displays on the display 41 that the operation of the opening and closing components is stopped due to the rain.

Subsequently, the cockpit DC 300 outputs information for instructing closing of the respective opening and closing components to the body DC 400 (S5). The body DC 400 controls the door 66, the window 85, and the sunroof 91 to be in the first condition for shutting off the vehicle interior space and the vehicle exterior space. Thereafter, the cockpit DC 300 waits for a period of time equal to or longer than a period of time required for closing the respective opening/closing components (S6), and then repeats the processes after S1.

On the other hand, when it is determined that it is not raining (S2: NO), the cockpit DC 300 releases the stopping of the operation instruction to the respective opening/closing components (S7). Subsequently, the cockpit DC 300 terminates the operation stop notification (S8). After that, the cockpit DC 300 waits for a certain period of time (S9), and then repeats the processes after S1. Note that the waiting time in S9 may be the same time as the waiting time (S6) after outputting the information instructing closing of the respective opening/closing components, or may be a different time.

When the write show ends (S1: YES), the cockpit DC 300 ends the write show execution-time operation stopping process. Incidentally, the cockpit DC 300 is controlled to release the stop of the operation instruction to the respective opening/closing components and to terminate the operation stop notification in accordance with the termination of the operation stop process at the time of executing the write show.

### Operation of the First Embodiment

According to the above-described light show execution processing, in addition to the music being output from the speaker 42 and the various movable parts of the vehicle 100 being operated, the light 57 of the vehicle 100 blinks.

Further, according to the above-described operation stop process at the time of executing a light show, when it is determined that rain is falling, an operation instruction for an opening/closing component that can be in a second state of connecting the vehicle interior space and the vehicle exterior space is stopped. Therefore, in the write show execution process, the music is output from the speaker 42 without the opening/closing component being operated. Further, according to the light show execution operation stop process, when it is determined that rain is falling, each opening/closing component is controlled to be in the first state of shutting off the vehicle interior space and the vehicle exterior space.

In particular, in the light show execution time operation stop process, when it is determined that rain is falling, the operation instruction for the opening/closing component that can be the second state connecting the in-vehicle space and the out-of-vehicle space among the movable parts is stopped, while the operation instruction for the movable part other than the opening/closing component is not stopped. Therefore, in the light show execution process, music is output from the speaker 42 without the respective opening and closing components being operated, and the movable parts different from the respective opening and closing components are operated.

### Effect of the 1 Embodiment

The effects of the present embodiment will be described.

(1-1) When the opening/closing component is operated, since the operation instruction to each opening/closing component is stopped when it is determined that it is raining, it is possible to suppress the wetting of the vehicle interior space.

(1-2) In particular, in a case where it is determined that it is raining, since the operation instruction to the door 66, the window 85, and the sunroof 91 is stopped, it is possible to prevent the interior space from being wetted due to the opening and closing parts being in the second state.

(1-3) The determination as to whether or not it is raining is performed in the operation stop process at the time of executing the light show. Therefore, when the user or the viewer is enjoyed by the combination of the music output and the operation of the movable part in the light show, it is possible to suppress the wetting of the vehicle interior space.

(1-4) Even in a case where it is determined that rain is falling, an operation instruction to a movable part that is not in the second state of connecting the vehicle interior space and the vehicle exterior space is not stopped. Therefore, the user and the viewer can be enjoyed by the combination of the output of music and the operation of the movable part while suppressing the wetting of the interior space in the light show.

(1-5) In particular, the side mirror 73 does not stop the operation instruction even when it is determined that it is raining. Therefore, the user and the viewer can be enjoyed by the combination of the music output and the operation of the side mirror 73 while suppressing the wetting of the vehicle interior space in the light show.

(1-6) In the display 41, an operation stop notification is executed, which is a notification indicating that the operation instruction to each opening/closing component is stopped, so that it is possible to prevent the user or the spectator from feeling uncomfortable because the opening/closing component does not operate in the light show.

(1-7) When it is determined that rain is falling in the light show execution-time operation stopping process, each opening/closing component is closed. Therefore, when the operation instruction to each opening/closing component is stopped, the opening/closing component is in the second state, so that wetting of the vehicle interior space can be suppressed.

(1-8) In the write-show execution-time operation stop process, it is repeatedly determined whether or not it is raining at regular time intervals during a period in which the write-show is being executed. Then, when it is determined that the rain is falling, the operation instruction to each opening and closing component is stopped, and when it is determined that the rain is not falling, the stop of the operation instruction to each opening and closing component is released. Therefore, it is possible to prevent the interior space from becoming wet even when rain falls during the execution of the light show. If the rain stops while the light show is being performed, the user and the viewer can be enjoyed by combining the operations of the opening and closing parts thereafter.

### Second Embodiment

### Operation Stop Processing at the Time of Executing the Write Show in the Second Embodiment

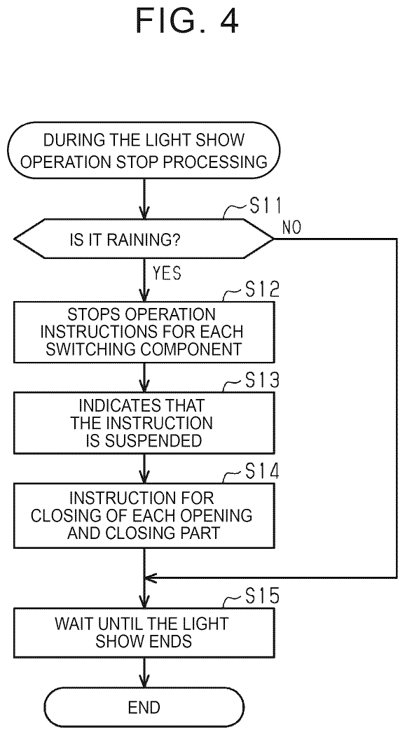

Next, a second embodiment of the present disclosure will be described with reference to FIG. 4. The cockpit DC 300 performs an operation stopping process at the time of executing the write show at the time of starting the write show.

As illustrated in FIG. 4, in the light show execution-time operation stopping process, the cockpit DC 300 determines whether it is raining (S11). When it is determined that it is raining (S11: YES), the cockpit DC 300 performs control so as to stop the operation instruction to the respective opening/closing components (S12). Subsequently, the cockpit DC 300 controls the display 41 to execute the operation stop notification (S13).

Subsequently, the cockpit DC 300 outputs information for instructing closing of the respective opening and closing components to the body DC 400 (S14). Then, the cockpit DC 300 waits until the light show ends (S15). Thereafter, the cockpit DC 300 ends the write show execution-time operation stopping process. Incidentally, the cockpit DC 300 releases the stop of the operation instruction to the movable part that is stopping the operation instruction in accordance with the end of the operation stop process at the time of executing the write show, and controls so as to terminate the operation stop notification.

### Operation and Effect of the 2 Embodiment

(2-1) In the light show execution time operation stop process of the second embodiment, after determining whether or not it is raining at the start of the light show, it waits until the light show ends. According to this, as compared with the case of repeating the determination of whether or not rain is falling every fixed time or every time the opening and closing component is operated, it is possible to simplify the process for stopping the operation instruction to each opening and closing component.

### Modifications

The present embodiment can be realized with the following modifications. The present embodiment and the following modifications can be combined with each other within a technically consistent range to be realized.

When the operation stop notification is executed on the display 41, the execution stop notification may be interrupted or terminated. When the operation stop notification is executed on the display 41, the operation stop notification and the execution notification may be executed in parallel.

The in-execution notification and the operation stop notification may be executed on different displays. The display 41 for executing the operation stop notification is not limited to the one provided in the vehicle 100, and may be, for example, a display of a mobile terminal held by a user. In this case, the cockpit DC 300 may be configured to provide the display of the mobile terminal of the user with information about the movable part whose operation instruction is stopped via the radio network.

The operation stop notification and the execution notification are not limited to those displayed on the display 41, and may be executed by, for example, audio output by the speaker 42 or blinking of the light 57. The operation unit 43 is not limited to the one provided in the vehicle 100, and may be, for example, an operation unit of a portable terminal held by a user. In this case, the cockpit DC 300 may be configured to execute the light show in response to the acquisition of the information indicating that the operation unit of the mobile terminal of the user is operated via the radio network.

The number and position of the cameras 15 may be changed as appropriate. The camera sensor device 10 is not limited to being connected to the driving support DC 200, and may be connected to a cockpit DC 300 or a body DC 400. In this case, the cockpit DC 300 may perform the rainfall determination process on the basis of information inputted from the camera sensor device connected to the cockpit DC 300 or the body DC 400.

The cockpit DC 300 may perform a rainfall determination process based on one of information about images around the vehicles 100 and information about raindrops.

The method of the rainfall determination process may be changed as appropriate. For example, instead of the cockpit DC 300, the driving support DC 200 or the body DC 400 may perform the rainfall determination process. In this case, the driving support DC 200 and the body DC 400 output the determination result of the rainfall determination process to the cockpit DC 300. The cockpit DC 300 may stop and release the operation instruction to the respective opening/closing components based on the determination inputted from the driving support DC 200 or the body DC 400.

The control device 500 may include a transmission/reception device that transmits position information of the vehicle 100 to an external server and receives rainfall information related to rainfall in an area corresponding to the position information. In this case, the control device 500 may perform the rainfall determination process on the basis of the rainfall information received from the external server via the transmission/reception device in place of or in addition to the information on the image around the vehicle 100 and the information on the detection result of the rainfall. The rainfall information may be information indicating whether or not it is raining in an area corresponding to the position information at the time of reception of the rainfall information, or may be information predicting whether or not it is raining within a predetermined time from the time of reception of the rainfall information.

In the case where the rainfall determination processing is performed based on a plurality of pieces of information, when it can be determined that the rainfall is occurring based on at least one piece of information, even when it cannot be determined that the rainfall is occurring based on other pieces of information, it may be determined that the rainfall is occurring. For example, it is assumed that rainfall determination processing is performed on the basis of information on an image around the vehicle 100, information on a detection result of raindrops, and rainfall information received from an external server via the transmission/reception device. In this case, when it can be determined that it is raining based on at least one of the information, even when it cannot be determined that it is raining based on other information, it may be determined that it is raining.

When the cockpit DC 300 determines that it is raining, it may be configured to output, to the body DC 400, ignore instruction information indicating that the operation instruction to the respective opening/closing components is ignored. In this case, the body DC 400 may stop the operation of the predetermined opening/closing component by ignoring the operation instruction information when the operation instruction information for instructing the operation of the predetermined opening/closing component is input after the input of the ignoring instruction information for the respective opening/closing components.

If the cockpit DC 300 determines that it is raining, it may deactivate the operation instruction to the movable part including the movable part that is not in the second condition. For example, if the cockpit DC 300 determines that it is raining, it may deactivate the operation instruction to all the movable parts.

In the light show execution operation stop process, the frequency of determining whether or not rain is occurring may be changed as appropriate. For example, the cockpit DC 300 may determine whether or not it is raining prior to the operation of the opening/closing component every time the opening/closing component is operated in the light show.

In the write show execution-time operation stopping process, the waiting time (S6 in FIG. 3) after outputting the information for instructing the closing of the respective opening/closing components may be changed as appropriate. For example, it may be a time less than the time it takes to close each opening and closing component.

There may be a plurality of types of music output from the speaker 42 in the light show. In this case, the music output by the operation of the operation unit 43 may be selected. There may be a plurality of types of program patterns for the light show. The program pattern of the light show may be configured to be settable by the user.

The timing at which the light show ends may be changed as appropriate. For example, the cockpit DC300 may terminate the light show when a predetermined period of time has elapsed since the light show started. The cockpit DC300 may terminate the light show based on an instruction from the operation unit 43.

Various electrical components operated in the light show may be changed as appropriate. For example, the hood, the oil supply port, the charging port, and the like of the vehicle 100 may be operated. In addition, any or all of a door, a mirror, a light, a window, and a sunroof may not be operated. That is, in the light show, at least one movable part may operate in accordance with the output of music from the speaker 42.

What is claimed is:

1. A control device for a vehicle
that is a control device for controlling a movable part applied to a vehicle equipped with the movable part that is able to switch between a first state in which space inside of a vehicle cabin and space outside of the vehicle are disconnected and a second state in which the space inside of the vehicle cabin and the space outside of the vehicle are connected, and
that is configured to execute rainfall determination processing for determining whether rainfall is occurring, wherein when determination is made that rainfall is occurring in the rainfall determination processing, the movable part is not controlled to the second state.

2. The control device according to claim 1, wherein the movable part includes at least one of a door and a power window.

3. The control device according to claim 1, wherein
the vehicle further includes a speaker,
the control device is configured to execute particular processing of outputting music from the speaker, and also operating the movable part, and
when determination is made in the rainfall determination processing that rainfall is occurring, music is output from the speaker without controlling the movable part to the second state in the particular processing.

4. The control device according to claim 3, wherein
the movable part is a first movable part,
the vehicle further is equipped with a second movable part that does not assume the second state,
the control device is configured to perform control to output music from the speaker, and also to operate the first movable part and the second movable part in the particular processing, and
when determination is made that rainfall is occurring in the rainfall determination processing, music is output from the speaker, and also the second movable part is operated, without controlling the first movable part to the second state in the particular processing.

5. The control device according to claim 4, wherein the second movable part is a side mirror.
